(19) United States
(12) Patent Application Publication
(10) Pub. No.: US 2025/0379493 A1
(43) Pub. Date: Dec. 11, 2025

(54) ELECTRIC MACHINE WITH A STATOR ASSEMBLY AND IMMERSION COOLING SYSTEM

(71) Applicant: DANA TM4 INC., Boucherville (CA)

(72) Inventors: Sabahattin DIZDAR, Montreal (CA); Babak SAKHAEI, Boucherville (CA)

(21) Appl. No.: 18/735,941

(22) Filed: Jun. 6, 2024

(51) Int. Cl. H02K 9/19; B60K 1/00; H02K 1/20; H02K 5/24

(52) U.S. Cl. CPC H02K 9/19; H02K 1/20; H02K 5/24; B60K 2001/006

(57) ABSTRACT

Systems and methods for a stator assembly in an electric machine. The stator assembly, in one example, includes a stator core that is mated with a stator sleeve at an interface that includes a first section that forms an interference fit between the stator core and the stator sleeve and an attachment device that axial retains the stator core within the stator sleeve. In the stator assembly, the stator sleeve includes a coolant deflector that is profiled to direct a coolant through stator end windings and into one or more coolant channels that extend through the stator core from an inlet side coolant chamber to an outlet side coolant chamber.

### TECHNICAL FIELD

The present disclosure relates to an electric machine with a stator assembly and an immersion cooling system for stator end windings.

### BACKGROUND AND SUMMARY

Some electric motors have made use of cooling systems in an attempt to increase motor efficiency. For instance, water jackets that surround the motor housing have been used to cool certain motors. Other motors have attempted to cool the stator using coolant that is routed closer to the stator in an effort to increase the amount of heat that can be removed from the stator.

U.S. Pat. No. 10,770,934 B2 to Jakob et al. discloses an electric machine with cooling channels that are formed between a housing sleeve and a stator sleeve. The fluid cooling medium in the channels may be water, oil, or air. The electric machine additional includes a Hirth joint to form a rigid connection between the housing sleeve and the stator sleeve.

The inventors have recognized several issues with the electric machine disclosed by Jacob as well as other previous electric machines. For instance, the inventors have recognized that certain vehicle platforms may demand additional stator cooling. Specifically, the inventors have recognized that end winding immersion cooling may be particularly effective in further increasing motor efficiency. However, in practice, incorporating immersion cooling capabilities into electric machines can present issues with regard to packaging, serviceability, and repair. For instance, incorporating immersion cooling into certain electric machines may present tradeoffs with regard to cooling performance and serviceability.

The inventors have recognized the aforementioned issues and developed a stator assembly for an electric machine to at least partially address the issues. The stator assembly includes, in one example, a stator core that is mated with a stator sleeve at an interface that includes a first section that forms an interference fit between the stator core and the stator sleeve. The stator assembly further includes an attachment device that axially retains the stator core within the stator sleeve. Further, in the stator assembly, the stator sleeve includes a coolant deflector that is profiled to direct a coolant through stator end windings and into one or more coolant channels that extend through the stator core from an inlet side to an outlet side. Routing the coolant through the stator end windings substantially increases cooling performance, when compared to other motors such as motors with water jackets. Further, using the interference fit interface and the attachment device enables the stator to be conceptually formed as a cartridge. Assembly, serviceability, and repair are enhanced as a result.

In one example, the interface includes a second section that forms a clearance fit between the stator core and the stator sleeve. Using a clearance fit and an interference fit in the interface formed between the stator core and the stator sleeve allows the stator assembly to be efficiently removed from an electric machine (in which the assembly is incorporated) for servicing, repair, etc. Designing the interface with the interference fit along solely a portion of the interface, allows comparatively higher stresses caused by tight pressing forces of the stator, to be reduced. Further, the attachment device (e.g., a lock nut) allows the stator core to be securely fixed in the sleeve with a reduced amount of stress. In this way, the likelihood of stator assembly degradation is decreased.

In another example, the stator sleeve may include one or more O-ring recesses that are profiled to receive O-rings that are configured to form a seal between the stator sleeve and an electric machine housing. The O-ring recesses and the O-rings correspondingly prevent a coolant shortcut between the crown end and the weld end of the windings. Additionally, the O-ring recesses and the O-rings also serve for ingress protection for external fluids. Further, the O-ring recesses and the O-rings, also function as bump stops during operation and enable noise, vibration, and harshness (NVH) to be reduced during electric machine operation.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 is a diagram of an exemplary system with an electric machine that includes an immersion cooling system.

FIG. 2 is a detailed cross-sectional view of an electric machine with a stator assembly and an immersion cooling system for the stator assembly.

FIG. 3 is an illustration of another exemplary electric machine that includes an immersion cooling system.

FIGS. 4-5 are detailed views of a stator core and stator end windings in the immersion cooling system, depicted in FIG. 3.

FIGS. 6-12 are different views of another example of an immersion cooling system.

### DETAILED DESCRIPTION

Electric machines with stator assemblies are described herein that conceptually function as cartridges and are designed with immersion end winding cooling functionality. The stator cartridge enables efficient machine assembly, servicing, and repair and allows a stator cooling system to be effectively incorporated into the stator assembly, thereby increasing electric machine efficiency and longevity due to the increased heat removal from the stator when compared to certain motor cooling systems that utilize water jackets around the motor housing. Further, the immersion cooling of the end windings enables gains in machine operating efficiency to be achieved. To realize these characteristics, the stator assembly may include a stator core that is fit into a stator sleeve via an interface that include one section which is interference fit and another section which is clearance fit to reduce stresses caused by the tight pressing forces, in one example. The stator assembly further includes an attachment device (e.g., lock nut) that attaches the stator core to the stator sleeve. Specifically, the attachment device allows a clamp load to be applied to the stator core to securely fix the stator core within the sleeve with a reduced amount of radial stress which comes from the pressing forces between the stator sleeve and the stator core. The reduction in pressing stresses allows the magnetic performance and durability of the electric machine to be increased when compared to machines with has a greater degree of interference fitting between. Further, the reduction in pressing stresses in the stator assembly allows manufacturing of the assembly to be simplified. The immersion cooling system includes coolant inlet at a crown end of the stator and a coolant outlet at the weld end of the stator assembly, in one example. The cooling system uses a coolant deflector in the stator sleeve to effectively direct coolant through the end windings. The stator sleeve may further include O-ring recesses that are designed to form a seal between the stator sleeve and an electric machine housing. In this way, an undesirable coolant leakage shortcut between the stator end windings at each axial side of the stator is inhibited, and the chance of ingress from external fluids is decreased. The O-rings serve a dual-use functionality by also functioning as bump stops, thereby reducing noise, vibration, and harshness (NVH) which may be caused by a flange contacting a carrier during machine operation, for example.

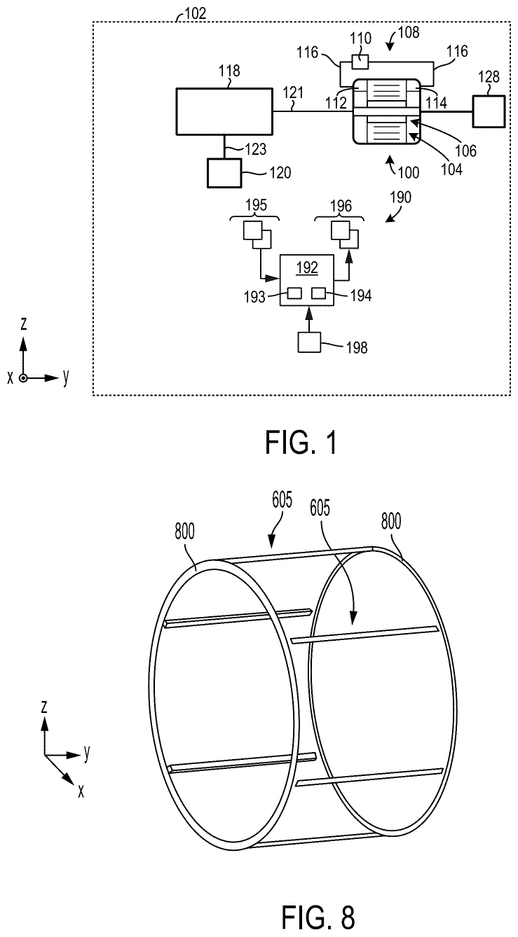

FIG. 1 shows an example of an electric machine 100 that may be included in a system 102, such as an electric vehicle (EV) or other suitable system. In the electric vehicle example, the electric machine may be a traction motor in an electric drive. Thus, the EV may be an all-electric vehicle or a hybrid electric vehicle (HEV) with an internal combustion engine. However, it will be understood that the electric machine 100 may be used in a variety of fields including, but not limited to, industrial machines, agricultural systems, mining systems, and the like.

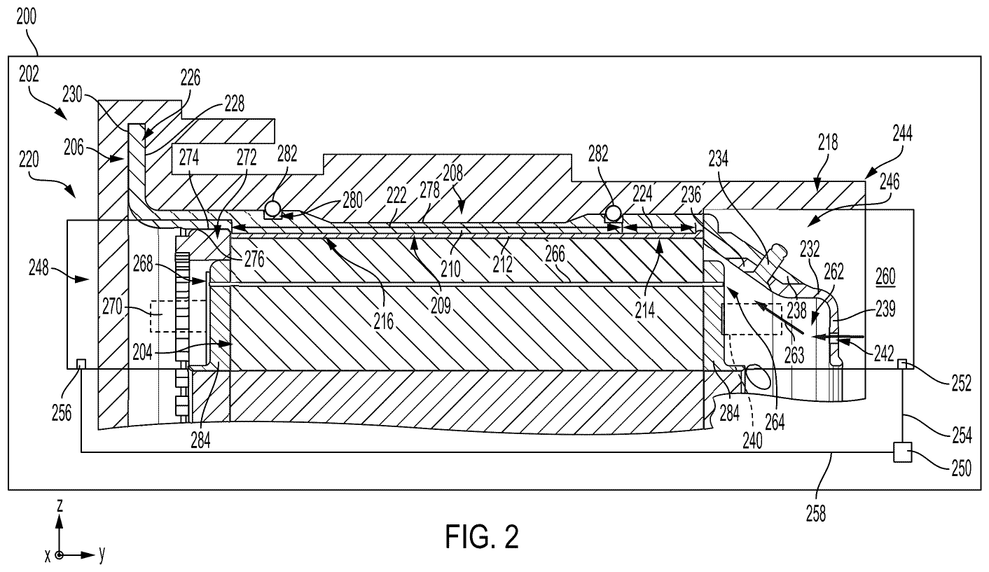

The electric machine 100 includes a stator assembly 104 and a rotor assembly 106. The electric machine 100 further includes a cooling system 108 (e.g., an immersion cooling system) for the stator assembly 104. The cooling system 108 includes a pump 110 which receives coolant (e.g., oil) from a coolant outlet 112 in the stator assembly 104 and delivers coolant to a coolant inlet 114 in the stator assembly 104. Ports such as fittings may be used to fluid couple coolant lines 116 to the pump 110. However, other coolant routing schemes in the cooling system are possible. The coolant inlet and the coolant outlet are positioned in regions around opposing stator end windings. Details related to the immersion cooling system and the stator assembly are expanded upon herein with regard to FIG. 2.

The cooling system 108 may further include a filter, valves, and the like. Further, in the illustrated example, the pump 110 is positioned external to the electric machine 100. However, it will be understood that the pump 110 may be incorporated into the electric machine or coupled to a housing of the electric machine in different configurations.

In the EV example, an inverter 118 may be electrically coupled to the electric machine 100 via electrical connection devices 121 such as wires, wiring harnesses, bus bars, combinations thereof, and the like. The inverter 118 may be electrically connected to an energy storage device 120 (e.g., one or more traction batteries, capacitor(s), fuel cell(s), combinations thereof, and the like) via electrical connection devices 123 such as wires, wiring harnesses, bus bars, combinations thereof, and the like. As such, electrical energy may flow between the inverter and the energy storage device during drive operation and regeneration operation, when the electric machine 100 is designed as a motor-generator.

The electric machine 100 may be coupled to downstream components 128. In the EV example, the downstream components 128 may include one or more drive axle assemblies, drive wheels, and the like.

The electric machine 100 may further include a control system 190 with a controller 192 as shown in FIG. 1. The controller 192 may include a microcomputer with components such as a processor 193 (e.g., a microprocessor unit), input/output ports, an electronic storage medium 194 for executable programs and calibration values (e.g., a read-only memory chip, random access memory, keep alive memory, a data bus, and the like). The storage medium may be programmed with computer readable data that represents instructions that are executable by a processor for performing the methods and control techniques described herein as well as other variants that are anticipated but not specifically listed. As such, control techniques, methods, and the like expanded upon herein may be stored as instructions in non-transitory memory.

The controller 192 may receive various signals from sensors 195 that are coupled to various regions of the electric machine 100 and the system 102 more generally. For example, the sensors 195 may include a rotor current sensor, an electric machine speed sensor, a stator current sensor, an electric machine temperature sensor, a battery state of charge sensor, an inverter current sensor, and the like. Electric machine speed may be ascertained from the amount of power sent from the inverter 118 to the electric machine 100. An input device 198 (e.g., accelerator pedal, brake pedal, drive mode selector, gear selector, combinations thereof, and the like, in the EV example) may further provide input signals indicative of an operator's intent for electric drive control.

Upon receiving the signals from the various sensors 195 of FIG. 1, the controller 192 processes the received signals, and employs various actuators 196 of the electric drive components to adjust the components based on the received signals and instructions stored on the memory of controller 192. For example, the controller 192 may receive a signal indicative of an operator's request for increased electric machine output. In response, the controller 192 may command operation of the inverter 118 to adjust the mechanical power output of the electric machine and increase the power delivered from the electric machine 100 to downstream components 128. The other controllable components in the electric drive may function in a similar manner in relation to sensor inputs and command outputs. For instance, the pump 110 may be controlled in a similar manner to drive coolant flow through the cooling system 108. A detailed example of a cooling system for a stator assembly is shown in FIG. 2 and discussed in greater detail herein.

An axis system is provided in FIG. 1, as well as FIG. 2, for reference. The z-axis may be a vertical axis (e.g., parallel to a gravitational axis), the x-axis may be a lateral axis (e.g., horizontal axis), and the y-axis may be a longitudinal axis, in one example. However, in other examples, the axes may have other orientations.

FIG. 2 shows an example of an electric machine 200 with a stator assembly 202. The electric machine 200 shown in FIG. 2 serves as an example of the electric machine 100, depicted in FIG. 1. The cutting plane for the cross-sectional view depicted in FIG. 2 extends through a rotational axis of the electric machine.

The stator assembly 202 includes a stator core 204 that is at least partially circumferentially enclosed by a stator sleeve 206. The stator sleeve 206 includes a body 208 in the illustrated example. The stator core 204 is pressed into an interior of the stator sleeve 206. To elaborate, the stator core 204 and the stator sleeve 206 for an interface 209 at an inner surface 210 of the sleeve and an outer surface 212 of the core. A section 214 of the interface 209 is formed via an interference fit and another section 216 of the interface is formed via a clearance fit, in the illustrated example. In this way, the pressing forces on the stator may be reduced, thereby increasing stator assembly longevity. To elaborate, the section 214 of the interface 209 is positioned adjacent to a crown side 218 of the stator assembly and therefore spaced away from a weld side 220 of the stator assembly. The section 216 is therefore positioned adjacent to the weld side 220. An axial length 222 of the section 216 may be greater than an axial length 224 of the section 214. However, other relative sizes of the sections have been contemplated.

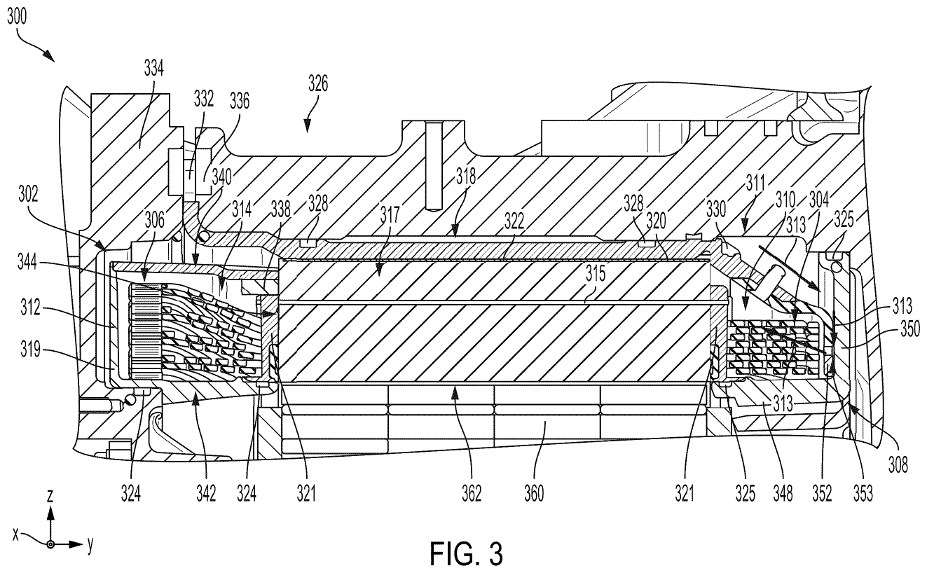

In the illustrated example, the stator sleeve 206 includes a flange 226 that extends radially outward from the body 208 of the sleeve. The flange 226 may specifically be arranged on the weld side 220 and includes an inboard surface 228 and an outboard surface 230. When the stator assembly 202 is incorporated into the electric machine, the flange 226 is coupled to an electric machine housing. The flange 226 allows the stator assembly to be efficiently incorporated into the electric machine. An exemplary electric machine housing that interfaces with a stator sleeve flange is shown in FIG. 3 and discussed in greater detail herein. Alternatively, the flange may be omitted from the stator sleeve.

In the example illustrated in FIG. 2, the stator sleeve 206 further includes a coolant deflector 232 that increase coolant flow through and around stator end windings 240, thereby increasing electric machine cooling and operating efficiency. In the illustrated example, the coolant deflector 232 is removably coupled to the body 208 via a deflector attachment device 234 (e.g., a rivet, a screw, combinations thereof, and the like). Specifically, a section 236 of the coolant deflector 232 may overlap a section 238 of the sleeve body 208, and the deflector attachment device 234 may extend through theses overlapping sections. However, in another example, the coolant deflector 232 and the body 208 may form a continuous structure and may therefore be formed out of the same material, in such an example. To elaborate, the sleeve body 208 and the coolant deflector 232 may be constructed out of steel or another suitable metal, in one specific example.

In another example, when the coolant deflector 232 is removably attached to the sleeve body 208, the body may be constructed out of steel or another suitable metal and the coolant deflector 232 may be constructed out of plastic. Constructing the deflector out of plastic reduces the weight of the stator assembly when compared to constructing the deflector out of a metal. In yet another example, the coolant deflector 232 may be overmolded on the sleeve body 208. In such an example, the deflector 232 may again be constructed out of plastic, and the sleeve body 208 may be constructed out of steel or another suitable metal.

The coolant deflector 232 includes a wall 239 that wraps around the stator end windings 240 to thereby at least partially enclose the end windings. An opening 242 extends (e.g., axially extends) through the wall 239. This opening 242 allows the coolant to achieve desired flow dynamics to increase end winding cooling, as discussed in greater detail below.

The stator assembly 202 includes an immersion cooling system 244 with an inlet side coolant chamber 246 and an outlet side coolant chamber 248. The inlet side coolant chamber 246 may receive coolant from a pump 250 at an inlet port 252. Coolant lines 254, conduits, combinations thereof, and the like may be used to fluidly couple the pump 250 and the inlet port 252. The outlet side coolant chamber 248 may be in fluidic communication with the pump 250 via an outlet port 256 via coolant lines 258, conduits, combinations thereof, and the like. The working fluid in the immersion cooling system 244 may be oil to avoid undesirable electromagnetic interaction between the fluid and the end windings when compared to systems that use a coolant which includes water.

The coolant immerses the end windings 240 in the illustrated example. To elaborate, coolant in a region exterior 260 to the coolant deflector 232 is directed through the opening 242 into a region 262 around the end windings 240. Arrows 263 depict the general direction of coolant flow through the immersion cooling system 244. However, it will be understood that in practice the coolant flow may exhibit greater complexity. The opening 242 forces coolant to flow through the crown end windings 240, instead of shortcutting directly to coolant channels 266. Coolant then flows through the end windings 240 and into inlets 264 of the coolant channels 266 that axially traverse the stator core 204. Outlets 268 of the coolant channels 266 open into the outlet side coolant chamber 248. From the outlets 268 coolant flows through and around end windings 270. Directing the coolant through the stator assembly 202 in the manner described above enables an increased amount of heat to be removed from the end windings and the stator core, thereby increasing electric machine performance.

An attachment device 272 (e.g., a lock nut which may have external threads 274) is attached to the stator sleeve 206 and enables a clamp load to be exerted on the stator core 204. The external threads 274 engage with internal threads 276 on a portion of the inner surface 210 of the stator sleeve 206. The use of the attachment device 272 enable solely a portion of the interface 209 to have an interference fit at its deep end, thereby reducing stresses in the interface between the sleeve and the core and increasing stator assembly longevity. The reduction in stresses enables the magnetic performance and the durability of the stator assembly to be increased and simplifies construction of the stator assembly. Further, the attachment device 272 enables the stator sleeve 206 to be removably attached to the stator core 204.

An outer surface 278 of the stator sleeve 206 includes O-ring recesses 280 that are profiled to receive O-rings 282. The O-rings 282 form a seal with the electric machine housing to prevent coolant from flowing through a shortcut between the crown side end windings and the weld side end windings. The sleeve body 208 may include a thinner section near the middle of the body and thicker sections near the axial ends of the body to enable the O-ring recesses 280 to be formed in the outer surface with a desired profile. However, other shapes of the body have been contemplated. The O-rings 282 may also function as bump stops for reducing NVH which may be caused by the flange 226 contacting internal walls of a carrier. Thus, the O-rings 282 may function as noise dampers. Further, balancing plates 284 may be coupled to opposing axial sides of the stator core 204. However, in other examples, the balancing plates 284 may be omitted from the stator assembly 202.

FIG. 3 shows another example of an electric machine 300 with a stator assembly 302 that employs immersion cooling for crown side end windings 304 and weld side end windings 306. The electric machine 300 may include at least a portion of the components and features of the electric machine 200, shown in FIG. 2. Redundant description of the overlapping components, features, etc. is omitted for brevity.

Walls 308 form a boundary of a crown side coolant chamber 310 for end winding cooling. To expound, an outer circumferential section 340 and an inner circumferential section 342 at least partially encloses the crown side end windings 304 and an attachment device 338, discussed in greater detail herein. Specifically, in the illustrated example, the outer circumferential section 340 is in face sharing contact with a crown side 344 of a stator core 317. Further, in the illustrated example, the inner circumferential section 342 is in sealing contact with an inner diameter of one of the balancing plates 321. However, the crown side coolant chamber may be bounded via another suitable cooling system architecture in other examples.

A coolant inlet 311 provides coolant to the crown side coolant chamber 310, in the illustrated example. Arrows 313 denote the general direction of coolant flow from the coolant inlet 311 to coolant channels 315 in the stator core 317. In this way, coolant flow on the outside of a deflector 352 is efficiently routed to the crown side end windings 304 for increased cooling. Further, walls 312 form a boundary of a weld side coolant chamber 314. An inner circumferential section 348 of the walls 312 may be in sealing contact with one of the balancing plates 321 and a radially extending section 350 of the walls 312 may extend along the coolant deflector 352 and be in sealing contact with a portion of a carrier housing 326. Further, a gap 353 may be formed between the radially extending section 350 and the deflector 352 to allow for coolant to flow therethrough. Seals for both crown side and weld side coolant chambers are discussed in greater detail herein.

An outlet 319 may be in fluidic communication with the weld side coolant chamber 314. The outlet 319 may be in fluidic communication with a coolant pump by way of a sump or directly fluidly coupled to the pump. Further, the weld side coolant chamber 314 and the crown side coolant chamber 310 are in fluidic communication via coolant channels 315 that axial extend through the stator core in the illustrated example. To elaborate, the coolant channels 315 may extend axially through the stator core 317 and balancing plates 321.

The stator assembly 302 again includes the stator core 317 that is mated at least partially within a stator sleeve 318. Again, an interface is formed between the stator core 317 and the sleeve 318 where a portion 320 is clearance fit and another portion 322 is interference fit, similar to the electric machine depicted in FIG. 2.

Seals 324 may be provided for the weld side coolant chamber 314. To elaborate, one of the seals 324 may be provided between one of the walls 312 and the carrier housing 326 and another one of the seals 324 may be provided between one of the balancing plates 321 and walls 312. Seals 325 may be provided for the crown side coolant chamber 310 to seal one of the balancing plates 321 and the carrier housing 326.

Seals 328 may be provided at an outer diameter of the stator sleeve 318 and the carrier housing 326. A triangular O-ring 330 may further be provided in the interface between the stator sleeve 318 and the carrier housing 326 to provide sealing and stiffness to the interface. The triangular O-ring 330 may alternatively be omitted, which may however decrease the stiffness of the stator assembly.

A flange 332 in the stator sleeve 318 is coupled to a flange 334 in the carrier housing 326 via attachment devices 336, in the illustrated example. An attachment device 338 (e.g., lock nut) is again used to attach the stator sleeve to the stator core, similar to the electric machine depicted in FIG. 2. Therefore, redundant description of the overlapping features is omitted for brevity. FIG. 3 further shows a rotor 360 with an air gap 362 between the rotor 360 and the stator core 317. The cutting plane for the cross-sectional view depicted in FIG. 3 extends through a rotational axis of the electric machine, similar to FIG. 2.

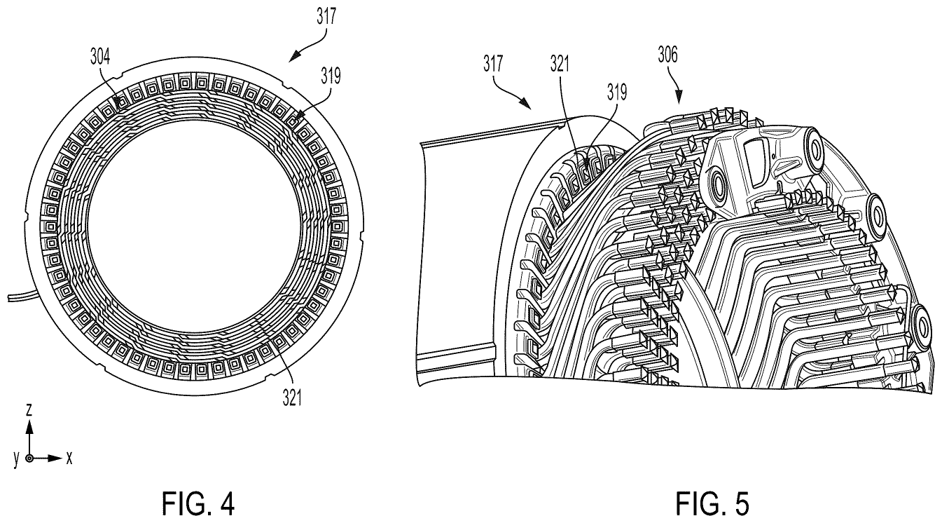

FIGS. 4 and 5 show a detailed view of the stator core 317 with the end windings 304 and 306, on the crown side and the weld side of the stator, respectively. The coolant channels 315 are further shown axially extending between the crown side and the weld side of the stator. The balancing plates 321 are further depicted in FIGS. 4-5.

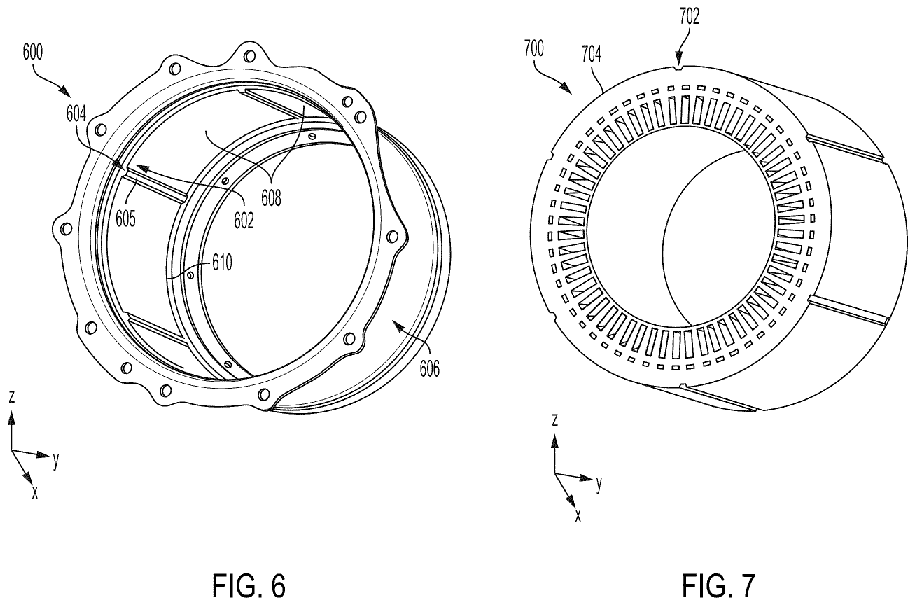

FIGS. 6 and 7 show a stator sleeve 600 and a stator core 700, respectively, that are included in another example of stator assembly. It will be appreciated that the stator assembly shown in FIGS. 6-7 may be included in any of the electric machines shown in FIGS. 1-3 or combinations of the electric machines. The stator sleeve 600 includes an inner surface 602 with multiple tabs 604 that axially extend along the interior of the sleeve. The tabs 604 radially extend inwardly towards the machine's rotational axis and may include side surfaces and a surface extending between the side surfaces, as expanded upon herein. Dampers 605 may be arranged on the tabs and between the tabs and recesses 702 in the stator core when assembled. Specifically, the dampers 605 are in face sharing contact with the surfaces of the tabs in the illustrated example.

The dampers 605 dampens vibration by compressing the dampener material, compensate for mechanical tolerances, and decrease mechanical stresses, thereby increasing machine longevity. The dampers 605 and the other dampers described here may be constructed out of a material that has a lower stiffness than metal such as plastic or elastomeric material.

The tabs 604 may be equally spaced around the inner circumference of the sleeve, in one example. However, non-equally spaced tabs have been contemplated. When the stator is assembled, the tabs 604 mate with multiple recesses 702 that are included in the stator core 700 shown in FIG. 7. Thus, the recesses 702 in the stator core axially extend along an outer surface 704 of the stator core. The stator sleeve 600 may further include a flange 606 for attaching the flange to other components in the assembly, in some examples. Sections 608 and 610 in the stator sleeve may form clearance gaps with the stator core, when assembled. In this way, the sleeve is able to more efficiently mate with the stator core, simplifying electric machine assembly.

FIG. 8 shows a perspective view of the dampers 605. In the illustrated example, the multiple dampers 605 are connected by rings 800 that are positioned on opposing sides of the dampers. In this way, the dampers may be efficiently installed in the sleeve. However, alternate damper configurations have been contemplated.

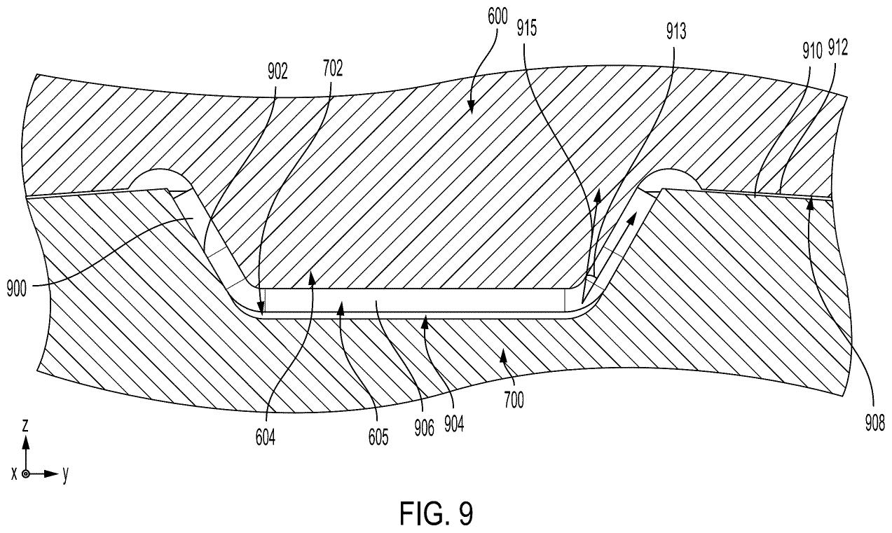

FIG. 9 shows a detailed cross-sectional view of a portion of the interface formed between the stator sleeve 600 and the stator core 700. The cutting plane for the cross-sectional view depicted in FIG. 9 extends through the rotational axis of the electric machine and is arranged perpendicular thereto. One of the tabs 604 and one of the dampers 605 are illustrated in FIG. 9.

In the example depicted in FIG. 9, sidewalls 900 of the damper 605 is shown in face sharing contact with a side surface 902 of the recess 702. A clearance 904 is formed between a wall 906 of the damper 605 that extends between the sidewalls 900, in the illustrated example. Another clearance 908 is formed between an outer surface 910 of the stator core 700 and an inner surface 912 of the stator sleeve 600.

The sidewalls 900 of the damper may form an angle 913 in relation to a radial axis 915 that is less than 90° in one example. However, sidewalls with other contours have been envisioned.

The dampers described herein reduce the chance of metal to metal contact between the stator sleeve and the stator core. In this way, the stator core is able to float within the stator sleeve, thereby increasing the longevity of the stator assembly due to a reduction in undesirable metal to metal contact between stator components.

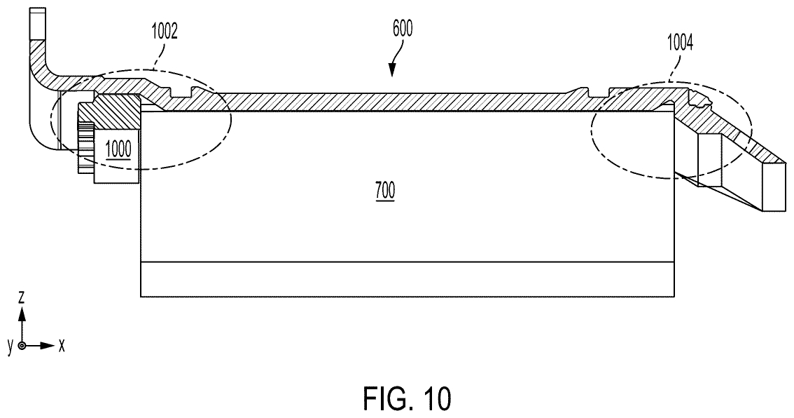

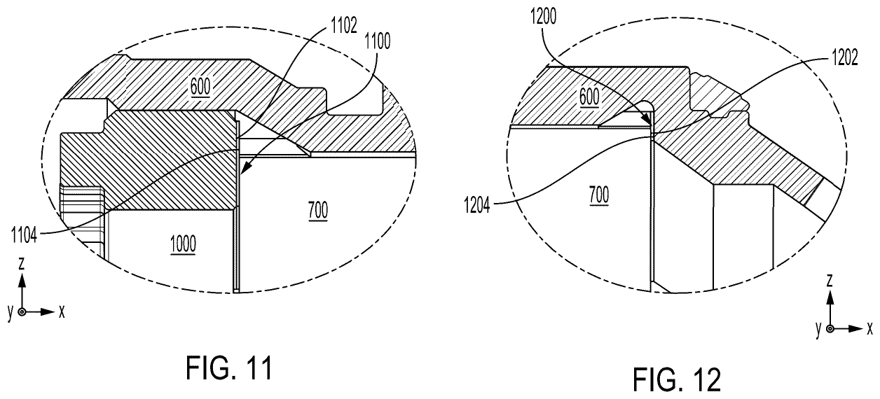

FIG. 10 shows another cross-sectional view of the stator sleeve 600 and the stator core 700. An attachment device 1000 (e.g., a lock nut) again attaches the stator sleeve 600 to the stator core 700. The boundary of the detailed view shown in FIG. 11 is indicated at 1002 and the boundary of the detailed view shown in FIG. 12 is indicated at 1004 in FIG. 10. Further, the cutting plane for the cross-sectional view depicted in FIG. 10 extends through a rotational axis of the electric machine, similar to FIGS. 2 and 3.

An axial damper 1100 is positioned between the attachment device 1000 and the stator core 700, in the example illustrated in FIG. 11. To elaborate, the axial damper 1100 is positioned between a side surface 1102 of the attachment device 1000 and a side surface 1104 of the stator core 700. The axial damper 1100 allows for further reductions in NVH during machine operation, thereby increasing customer appeal and machine longevity.

Another axial damper 1200 is shown in FIG. 12. The axial damper 1200 is arranged between a side surface 1202 of the stator core 700 and an interior surface 1204 of the stator sleeve 600. In this way, NVH during machine operation is even further reduced. However, in alternate examples, at least one of the dampers in FIGS. 11 and 12 may be omitted from the stator assembly. The axial dampers shown in FIGS. 11 and 12 dampen axial movement to further reduce mechanical stresses in the stator assembly. The axial dampers may again be constructed out of plastic or elastomer.

The cooling systems and stator assemblies described herein simplify electric machine serviceability, decrease stator stresses, enhance coolant routing through the stator and stator sealing, and decrease NVH during machine operation. Custom appeal is increased as a result.

FIGS. 1-12 provide for a method for operation of a cooling system in a stator assembly. The method includes operating a coolant pump to circulate coolant through an immersion coolant system. To elaborate, coolant flows from the pump to an inlet side coolant chamber and through a coolant deflector and through crown end windings to axial coolant channels that traverse a stator core. From the axial channels coolant flows into an outlet side coolant chamber and from the outlet side coolant chamber back to the pump. In this way, an increased amount of heat is able to be removed from the stator assembly, thereby increasing machine performance. It will be understood, that the method may be implemented as instructions stored in memory that are executable by a processor of a controller.

The technical effect of the cooling system operating method described herein is to increase electric machine performance by increasing the amount of heat that is able to be removed from the stator assembly, simplifying assembly of the stator, and decrease stresses between a stator sleeve and a stator core thereby increasing stator longevity.

FIGS. 1-12 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Additionally, elements co-axial with one another may be referred to as such, in one example. Further, elements shown intersecting one another may be referred to as intersecting elements or intersecting one another, in at least one example. Further still, an element shown within another element or shown outside of another element may be referred as such, in one example. In other examples, elements offset from one another may be referred to as such.

The invention will be further described in the following paragraphs. In one aspect, a stator assembly is provided that comprises a stator core that is mated with a stator sleeve at an interface; wherein the interface includes a first section that forms an interference fit between the stator core and the stator sleeve; and an attachment device that axial retains the stator core within the stator sleeve; wherein the stator sleeve includes a coolant deflector that is profiled to direct a coolant through stator end windings and into one or more coolant channels that extend through the stator core from an inlet side coolant chamber to an outlet side coolant chamber. In one example, the coolant deflector may at least partially surround stator end windings. In another example, the coolant deflector may include an opening that axially extends through a wall of the coolant deflector. In another example, the interface may include a second section that forms a clearance fit between the stator core and the stator sleeve. In yet another example, the first section may be positioned axially adjacent to the inlet side coolant chamber. In another example, the stator sleeve may include a flange that extends radial outward and is configured to couple to an electric machine housing. In another example, the flange may be positioned radially outward from the outlet side coolant chamber. In yet another example, the stator sleeve may include one or more O-ring recesses profiled to receive O-rings that are configured to form a seal between the stator sleeve and an electric machine housing. In another example, the coolant deflector may be coupled to a body of the stator sleeve via an attachment device. In another example, the coolant deflector may be constructed out of plastic. In another example, the attachment device may be a lock nut. In another example, the coolant may be oil.

In another aspect, a method for operation of a cooling system in a stator assembly is provided that comprises flowing coolant to a coolant inlet in the stator assembly; and flowing coolant through an opening that extends through a wall of a coolant deflector that at least partially surrounds stator end windings; wherein the stator assembly includes: a stator core that is mated with the stator sleeve at an interface that includes an interference fit along a first section of the interface; and an attachment device that axially retains the stator core within the stator sleeve; wherein the stator sleeve includes the coolant deflector. In one example, the method may further comprise flowing coolant from an end winding chamber to one or more coolant channels that axially extend through the stator core. In one example, the interface may include a second section that is clearance fit between the stator core and the stator sleeve and is positioned axially between the attachment device and the first section.

In another aspect, a stator assembly is provided that comprises a stator core that is mated with a stator sleeve at an interface that includes: a first section that forms an interference fit between the stator core and the stator sleeve; and a second section that forms a clearance fit between the stator core and the stator sleeve; an attachment device that axial retains the stator core within the stator sleeve; wherein the stator sleeve includes an oil deflector that is profiled to direct an oil through stator end windings and into one or more oil channels that extend through the stator core from an inlet side coolant chamber to an outlet side coolant chamber; wherein the oil deflector at least partially surrounds the stator end windings; and wherein the oil deflector includes an opening that extends through a wall of the oil deflector. In one example, the second section may be positioned adjacent to the oil inlet. In one example, the stator sleeve may include a flange that is positioned radial outward from the oil outlet and is configured to couple to an electric machine housing. In another example, the oil deflector is constructed out of plastic and a body of the stator sleeve is constructed out of steel. In another example, the stator sleeve may include O-ring recesses profiled to receive O-rings that are configured to form a seal between the stator sleeve and an electric machine housing.

In another aspect, a stator assembly is provided that comprises a stator sleeve that is mated with a stator core and includes: a plurality of axially extending tabs that mate with a plurality of recesses in the stator core; and an attachment device that axial retains the stator core within the stator sleeve; wherein a clearance fit is formed between at least a portion of the stator sleeve and the stator core; wherein the stator sleeve includes an oil deflector that is profiled to direct an oil through stator end windings and into one or more oil channels that extend through the stator core from an inlet side oil chamber to an outlet side oil chamber; wherein the oil deflector at least partially surrounds the stator end windings; and wherein the oil deflector includes an opening that extends through a wall of the oil deflector. In one example, the plurality of axially extending tabs may each include a tab damper that is constructed out of plastic or elastomer. In another example, sides of the tab dampers may be in face sharing contact with the stator core and a surface that extends between the sides may forms clearance fit with the stator core. In another example, the stator assembly may further comprise a first axial damper positioned between the attachment device and the stator core. In another example, the stator assembly may further comprise a second axial damper positioned between an axial side of the stator core and an inner surface of the stator sleeve.

In another representation, an immersion cooling system in stator assembly is provided. The immersion cooling system includes an oil deflector that is included in a stator sleeve profiled to direct oil through end windings and into axial oil channels that traverse a stator core, wherein the stator sleeve is interference fit with the stator core at solely a portion of a fit interface that is formed between the stator sleeve and the stator core.

While various embodiments have been described above, it should be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive. As such, the configurations and routines disclosed herein are exemplary in nature, and that these specific examples are not to be considered in a limiting sense, because numerous variations are possible. For example, the above technology can be applied to a variety of systems that include electric drives with different types of propulsion sources including internal combustion engines, in a hybrid vehicle example. The subject matter of the present disclosure includes all novel and non-obvious combinations and sub-combinations of the various systems and configurations, and other features, functions, and/or properties disclosed herein.

Note that the example control and estimation routines included herein can be used with various electric drive and/or system configurations. The control methods and routines disclosed herein may be stored as executable instructions in non-transitory memory and may be carried out by the control system including the controller in combination with the various sensors, actuators, and other electric drive and/or system hardware in combination with the electronic controller. As such, the described actions, operations, and/or functions may graphically represent code to be programmed into non-transitory memory of the computer readable storage medium in the electric drive and/or the system. The various actions, operations, and/or functions illustrated may be performed in the sequence illustrated, in parallel, or in some cases omitted. Likewise, the order of processing is not necessarily required to achieve the features and advantages of the examples described herein, but is provided for ease of illustration and description. One or more of the illustrated actions, operations and/or functions may be repeatedly performed depending on the particular strategy being used. One or more of the method steps described herein may be omitted if desired.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A stator assembly, comprising:
a stator core that is mated with a stator sleeve at an interface;
wherein the interface includes a first section that forms an interference fit between the stator core and the stator sleeve; and
an attachment device that axially retains the stator core within the stator sleeve;
wherein the stator sleeve includes a coolant deflector that is profiled to direct a coolant through stator end windings and into one or more coolant channels that extend through the stator core from an inlet side coolant chamber to an outlet side coolant chamber.

2. The stator assembly of claim 1, wherein the coolant deflector at least partially surrounds stator end windings.

3. The stator assembly of claim 1, wherein the coolant deflector includes an opening that axially extends through a wall of the coolant deflector.

4. The stator assembly of claim 1, wherein the interface includes a second section that forms a clearance fit between the stator core and the stator sleeve.

5. The stator assembly of claim 4, wherein the first section is positioned axially adjacent to the inlet side coolant chamber.

6. The stator assembly of claim 1, wherein the stator sleeve includes a flange that extends radial outward and is configured to couple to an electric machine housing.

7. The stator assembly of claim 6, wherein the flange is positioned radially outward from the outlet side coolant chamber.

8. The stator assembly of claim 1, wherein the stator sleeve includes one or more O-ring recesses that are profiled to receive O-rings that are configured to form a seal between the stator sleeve and an electric machine housing.

9. The stator assembly of claim 1, wherein the coolant deflector is coupled to a body of the stator sleeve via a deflector attachment device.

10. The stator assembly of claim 9, wherein the coolant deflector is constructed out of plastic.

11. The stator assembly of claim 1, wherein the attachment device is a lock nut.

12. The stator assembly of claim 1, wherein the coolant is oil.

13. A method for operation of a cooling system in a stator assembly, comprising:
flowing coolant to an inlet side coolant chamber in the stator assembly; and
flowing coolant through an opening that extends through a wall of a coolant deflector that at least partially surrounds stator end windings;
wherein the stator assembly includes:
a stator core that is mated with a stator sleeve at an interface that includes an interference fit along a first section of the interface; and
an attachment device that axial retains the stator core within the stator sleeve;
wherein the stator sleeve includes the coolant deflector.

14. The method of claim 13, further comprising flowing coolant from an end winding chamber to one or more coolant channels that axially extend through the stator core.

15. The method of claim 13, wherein the interface includes a second section that is clearance fit between the stator core and the stator sleeve and is positioned axially between the attachment device and the first section.

16. A stator assembly, comprising:
a stator sleeve that is mated with a stator core and includes:
a plurality of axially extending tabs that mate with a plurality of recesses in the stator core; and
an attachment device that axial retains the stator core within the stator sleeve;
wherein a clearance fit is formed between at least a portion of the stator sleeve and the stator core;
wherein the stator sleeve includes an oil deflector that is profiled to direct an oil through stator end windings and into one or more oil channels that extend through the stator core from an inlet side oil chamber to an outlet side oil chamber;
wherein the oil deflector at least partially surrounds the stator end windings; and
wherein the oil deflector includes an opening that extends through a wall of the oil deflector.

17. The stator assembly of claim 16, wherein the plurality of axially extending tabs each include a tab damper that is constructed out of plastic or elastomer.

18. The stator assembly of claim 17, wherein sides of the tab dampers are in face sharing contact with the stator core and a surface that extends between the sides forms a clearance fit with the stator core.

19. The stator assembly of claim 16, further comprising a first axial damper positioned between the attachment device and the stator core.

20. The stator assembly of claim 19, further comprising a second axial damper positioned between an axial side of the stator core and an inner surface of the stator sleeve.
